(19) United States
(12) Patent Application Publication
(10) Pub. No.: US 2005/0057438 A1
(43) Pub. Date: Mar. 17, 2005

(54) Apparatus and method for producing three-dimensional motion picture images

(76) Inventor: Roberto Luis Garcia Remes, Mexico D.F. (MX)

Correspondence Address: KEELING HUDSON LLC, P.O. BOX 70103, HOUSTON, TX, 77270, US

(21) Appl. No.: 10/928,963

(22) Filed: Aug. 27, 2004

Related U.S. Application Data
(60) Provisional application No. 60/498,821, filed on Aug. 29, 2003.

(51) Int. Cl. G09G 5/00

(52) U.S. Cl. 345/4

(57) ABSTRACT

A method and apparatus for producing two-dimensional images of a scene on a substantially flat viewing surface to enable perception of three dimensions comprises arranging a plurality of optical recorders into two recorder arrays, recording a series of images simultaneously with each optical recorder, and sequencing the recorded images onto a final recording medium. The first recorded images of each series from each optical recorder are sequentially arranged, followed by the second recorded images, the third recorded images and so on. To view the final recording in real time, the final recording is displayed at a rate equal to the recording rate of the optical recorders multiplied by the number of optical recorders used.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates to a method for recording a series of images by a plurality of optical recorders, sequencing selected images recorded by the optical recorders, and displaying the sequenced images on a two-dimensional medium wherein the display is perceived by a viewer as a three-dimensional image.

2. Description of the Related Art

Prior art methods of creating a perception of 3D images, such as 3D movies and holograms, are based on perception of the eye. Variances in light refracted by an object aid in the perception of depth by the eye.

There are several ways that the perception of depth is communicated to a viewer in the context of a motion picture. One common method is the use of two cameras spaced apart by a predetermined distance. Polarized lenses are necessary to view the motion picture and perceive depth.

U.S. Pat. No. 4,993,828 issued to Shaw et al. on Feb. 19, 1991 discloses a camera for producing 3D motion pictures in which there are camera lenses corresponding to the left eye and the right eye. Each lens has a corresponding film transport mechanism. Manipulation of the film strip is necessary before viewing. Two simultaneous projectors having polarized filters are used to view the film. Viewers must wear polarized glasses, which correspond to the polarized filters on the projectors, to perceive depth while watching the motion picture.

U.S. Pat. No. 4,957,361 issued to Shaw on Sep. 19, 1990 discloses a method of producing and displaying 3D motion pictures wherein tow master film negatives are prepared using a camera rig with one camera that looks directly at the subject through a semi-transparent mirror and a second camera that looks at the same subject by way of the reflective surface of the mirror to obtain left and right eye images. The cameras are oriented so that the mirror images recorded by the second camera are turned laterally of the film in being reflected by the mirror. Images from the two films are simultaneously projected onto the same screen to produce a coincident 3D image. Left and right eye images are optically coded by using polarized filters, requiring the viewer to wear spectacles having corresponding polarized lenses to perceive depth while viewing the motion picture.

U.S. Pat. No. 3,518,929 issued to Glenn, Jr. on Jul. 7, 1970 discloses a parallax stereogram 3D camera, which utilizes a plurality of cameras having optical axes convergent upon the object to be photographed and displayed in 3D. A common shutter drive mechanism is used to provide uniform 3D display.

Other prior art methods of producing 3D images include the use of lenticular screens for viewing the images.

U.S. Pat. No. 5,049,987 issue to Hoppenstein on Sep. 17, 1991 discloses a method and apparatus for creating 3D television or other multi-dimensional images. A plurality of image-capturing devices is arranged in a predetermined pattern about the target object. The image from each capturing device is divided into a plurality of equally sized strips by a lenticular device located between the image capturing devices and the target object. A second lenticular device, having similar optical characteristics as the first lenticular device, is located adjacent to display means. Superimposed images taken from a plurality of cameras are used to provide the perception of depth to a viewer.

U.S. Pat. No. 5,430,474 issued on Jul. 4, 1995 and U.S Pat. No. 5,614,941 issued on Mar. 25, 1997 both to Hines, disclose a system for creating stereoscopic images viewable without the need for special glasses. Images from multiple sources from predetermined lateral directions are superimposed on a viewing screen. The screen upon which the 3D image is displayed includes a Fresnel lens, a diffuser, and a lenticular screen with horizontal lenticules.

Another prior art method of producing a 3D image sensation in the viewer includes U.S. Pat. No. 4,062,045 issued to Iwane on Dec. 6, 1977. This patent discloses a 3D television system for photographing an object at a plurality of different planes to obtain an individual picture of the image corresponding to each plane. Each planar image is then angularly divided into a pattern distribution of brightness and depth signals. A transmission means is utilized to classify the image signals and transmit them to a receiving and reprocessing unit. The reprocessing unit reassembles the brightness and depth signals from the plurality of planar images from the plurality of cameras.

It would be an improvement to the art to be able to experience a three-dimensional sensation when viewing a motion picture without the need for special glasses or a special viewing screen.

### BRIEF SUMMARY OF THE INVENTION

Accordingly, it is an object of the present invention to provide a perception of 3D images in a motion picture that is viewable without the use of polarized lenses.

It is another object of this invention to provide a perception of 3D images in a motion picture that may be viewed on an ordinary projection screen.

It is another object of this invention to replicate variations in focal length of human eyes with a plurality of cameras.

The present invention is an apparatus and method to provide a perception of 3D images by sequentially displaying a plurality of 2D images recorded by a plurality of vertically and horizontally spaced optical recorders. The images are recorded and displayed at a high speed, such that the viewer processes in such rapid succession that the images are perceived as being viewed simultaneously. The vertically and horizontally spaced optical recorders capture nuances of lighting and space similar to that perceived by the human eye when viewing a 3D object, a plurality of objects or a scene. The spaced optical recorders additionally provide a triangulation similar to the effect of viewing an object from two spaced eyes.

Other features and advantages of the invention will be apparent from the following description, the accompanying drawing and the appended claims.

### BRIEF DESCRIPTION OF THE DRAWINGS

FIG. 1 is a front view of a first embodiment of an optical recorder arrangement.

FIG. 2 is a perspective view of an optical recorder.

FIG. 3 is a cut-away view of an optical recorder.

FIG. 4 is a perspective view of first and second recorder arrays having a plurality of optical recorders focused on an object while recording a scene.

FIG. 5 is a front view of a matrix embodiment of an optical recorder arrangement.

FIG. 6 is a depiction of a plurality of serial images, each of which is from a different optical recorder.

FIG. 7 is a depiction of a sequenced image series.

### DESCRIPTION OF THE INVENTION

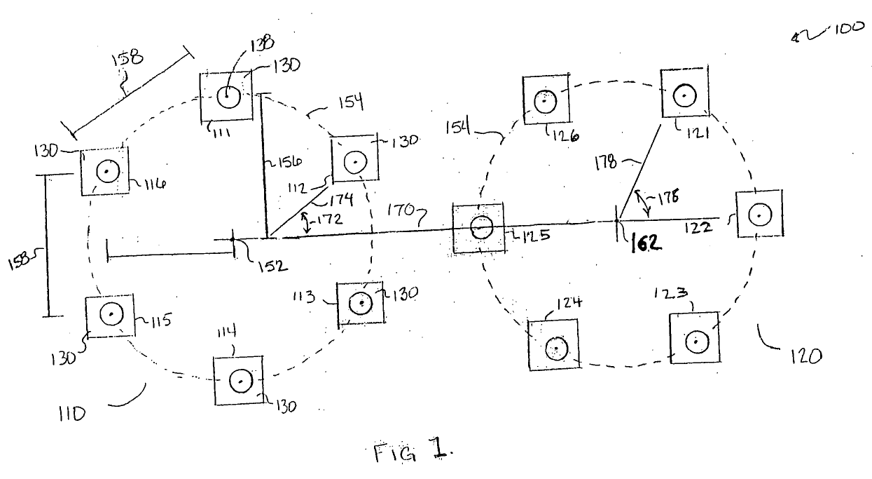

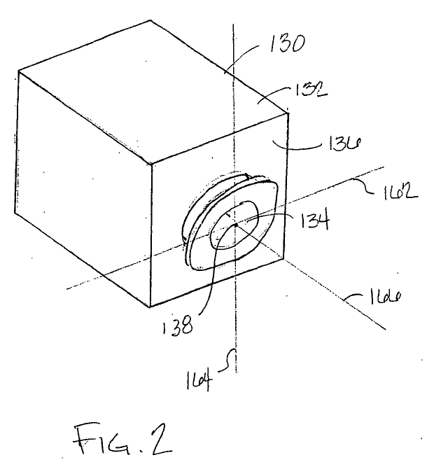

Referring to FIGS. 1 and 2, an illustrative arrangement 100 of optical recorders 130 is provided. As used herein, the term, “optical recorder” refers to any type of device that includes an aperture through which an image, or series of images, may be captured and which has the capability of recording the image, or series of images onto a recording medium. The term “recording medium” may be film, digital memory, digital storage devices, or any other medium on which a series of images may be recorded and stored, temporarily or permanently. Optical recorders are generically describe herein as optical recorders 130, but may also be assigned an individual description, such as optical recorder 111.

In a preferred embodiment, arrangement 100 comprises two sets of optical recorders 130, a first recorder array 110 and a second recorder array 120. Optical recorders 130 in first recorder array 110 are positioned around a first array center point 152 in a recorder location 111-116 located a radius distance 156 from first array center point 152. Optical recorders 130 in second recorder array 120 are positioned around a second array center point 162 in a recorder location 121-126 located a radius distance 166 from second array center point 162. In the embodiment shown, first and second recorder arrays 110, 120 each have six such locations, 111-116, 121-126, however there may be as few as two optical recorders 130 per recorder array 110, 120 or more than the six depicted.

First and second recorder arrays 110 and 120 are spaced from each other. For simplicity, first recorder array 110 is described as being to the left of second recorder array 120. However, array 120 may be to the left of first recorder array 110 without affecting the outcome. Also, the configuration described for first recorder array 110 may be applied to second recorder array 120 while the configuration described for second recorder array 120 is applied to first recorder array 110.

Continuing to refer to FIG. 1, each recorder location 111-116 in first recorder array 110 is separated by a recorder spacing distance 158. A recorder spacing distance 168 separates each recorder location 121-126 in second recorder array 120. Recorder locations 111-116 in first recorder array 110 are coplanar, as are recorder locations 121-126 in second recorder array 120. When array 110 is arranged such that the plane containing recorder locations 111-116 is vertical, the recorder locations 111-116 are spaced horizontally and vertically in relation to each other. When array 120 is arranged such that the plane containing recorder locations 121-126 is vertical, the recorder locations 121-126 are spaced horizontally and vertically in relation to each other.

In the embodiment depicted, first and second recorder arrays 110 and 120 are also coplanar, resulting in all recorder locations 111-116, 121-126 being fixed in a common plane. First and second recorder arrays 110 and 120 are not required to be co-planar to practice the invention, but if not co-planar, should be oriented so that lines passing through array center point 152 and second array center point 162 normal to the planes of recorder arrays 110 and 120 converge at a location distal from arrays 110 and 120.

An array fixture (not shown) may be arranged to hold all optical recorders 130 in an assigned recorder location 111-116, 121-126.

In the embodiment depicted, radius distance 156 or 166 and recorder spacing distance 158 or 168 are equivalent as array 110 comprises six recorder locations 111-116 equally spaced circumferentially from center point 152, each recorder location 111-116 a distance 158 from center point 152, with array 120 having similar recorder locations 121-126.

In the embodiment depicted by FIG. 1, recorder locations 111-116 in first recorder array 110 and recorder locations 121-126 in second recorder array 120 are not mirror images of each other. Recorder locations 111-116 in first recorder array 110 are rotated from the counterpart recorder locations 121-126 in second recorder array 120 relative to a straight line 170 between first array center point 152 and second array center point 162. For example, a first array location angle 172 is defined between a line 174 from a recorder location 112 to first array center point 152 and line 170. Recorder location 121 in second array 120 corresponds to recorder location 112 in first array 110. A second array location angle 176 is defined between a line 178 from recorder location 121 to second array center point 162 and imaginary line 170. In the embodiment depicted, the offset will be such that angle 176 is 1.5 times angle 174. Stated differently, the recorders 130 of second array 120 are offset from the recorders 110 by one-half of the angular displacement of any two adjacent recorders 130 of either array.

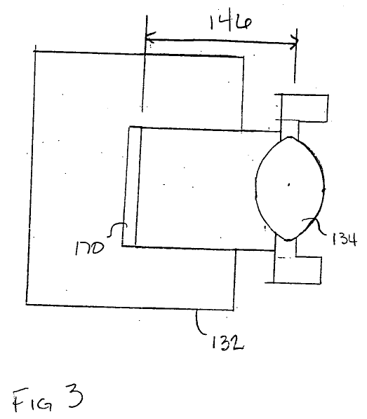

Referring to FIGS. 2 and 3, each optical recorder 130 includes a recorder housing 132 and a lens 134. Recorder housing 132 includes a front end 136 to which lens 134 is attached. Lens 134 is constructed to collect and focus an image on recording medium 170 (shown in FIG. 3).

In an initial position, lens 134 faces in a forward direction so that a direction line 166 through center point 138 is perpendicular to the plane of the respective array 110, 120. Lens 134 may be movably attached to front end 136 such that direction line 166 is in an angularly displaced position with respect to the initial position. Alternatively, optical recorder 130 is movable so that direction line 166 is angularly displaced. Preferably, either lens 134 or optical recorder 130 is movable so that the angular displacement of direction line 166 is similar to the angular displacement of the human eye when an individual's head is held in a stationary position and the eye is moved within the socket to follow an object in motion.

Depending on the application, recorders 130 may comprise auto-focusing cameras as commercially practiced and may include tracking capabilities as currently commercially practiced.

Referring to FIG. 3, a recording medium 170 is housed within recorder housing 132.

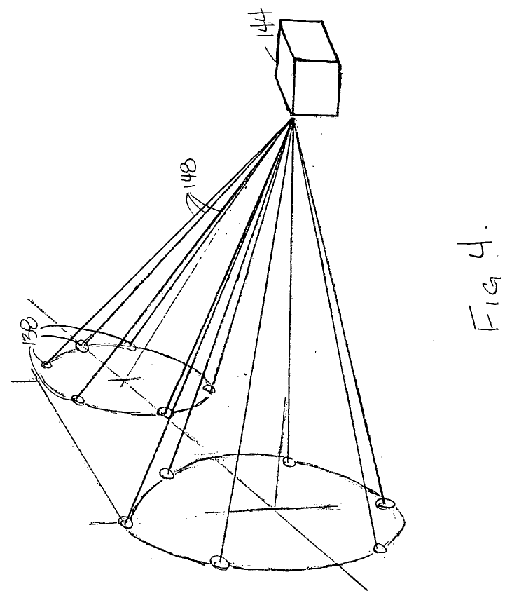

Referring to FIG. 4, the distance between the center point 138 of each lens 134 and an object 144 of which an image is being recorded is an object distance 148. To simulate the perception by human eyes, first and second recorder arrays 110, 120 should be oriented such that the object 144 is in front of first and second recorder arrays 110, 120 and such that each optical recorder 130 has an unobstructed view of object 144. It is noted that object 144 provides a focal point and that optical recorder 130 records the scene encompassing the object 144 as well as objecto 144.

After first and second recorder arrays 110 are positioned relative to an object 144 to be recorded, recording may commence. All optical recorders 111-116, 121-126 in first and second recorder arrays 110, 120 record the scene which includes object 144. Such recording may be simultaneous or may be sequential, but in rapid succession. The present invention contemplates rapid, successive recording of object 144 and the scenery recorded therewith, and recording dynamic movement of object 144 and the scenery recorded therewith.

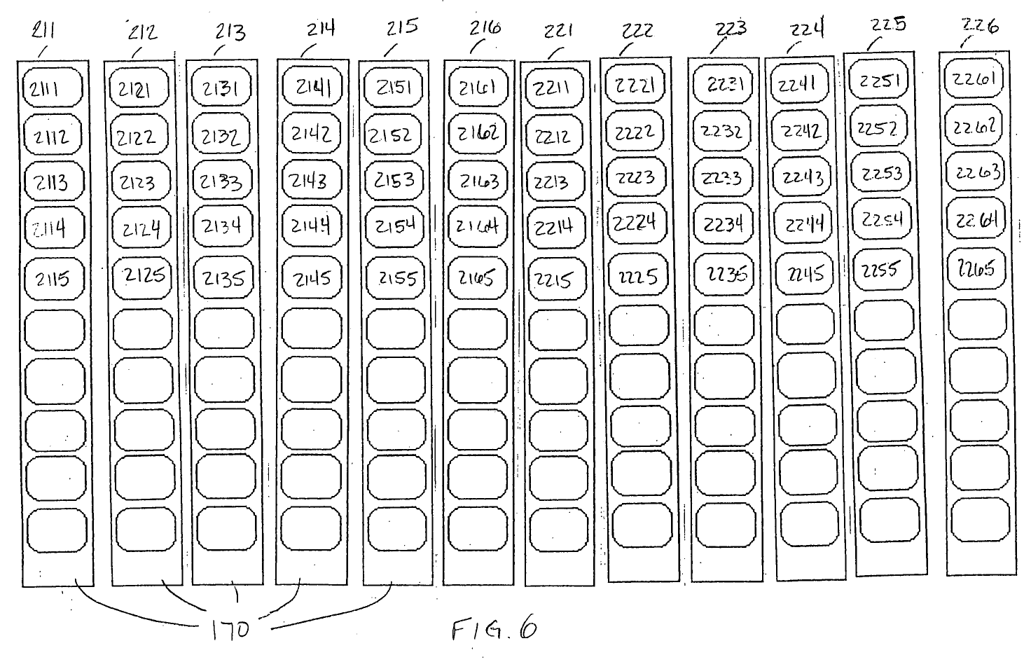

Referring to FIGS. 4 and 6, each optical recorder 111-116, 121-126 records an individual series of images 211-216, 221-226 onto a recording medium 170. There may be an individual recording medium 170 associated with each optical recorder 111-116, 121-126 or there may be one recording medium 170 onto which serial images 211-216, 221-226 are simultaneously recorded.

In the preferred embodiment, each optical recorder 130 of each optical recorder 130 is constructed to rotate as required to track movement of an identified object 144. Alternatively, each optical recorder 130 may be in a fixed position with the lens 134 constructed to rotate as required to track movement of an identified object 144.

In the preferred embodiment, the operation of arrays 110 and 120 simulate vision by a pair of eyes. During recording, object 144 is the focal point of optical recorders 111-116 of first recorder array 110 and is also the focal point of optical recorders 121-126 in the second recorder array 120, involving slight rotation of the recorders 130 to align the direction lines 166 of each recorder 130 to object 144. Optical recorders 111-126 of first recorder array 110 and optical recorders 121-126 of second recorder array 120 simultaneously and responsively rotate as required to follow the movement of object 144.

In an alternative embodiment, recorders 130 are in a fixed position and lenses 134 rotate to follow movement of object 144.

Each optical recorder 111-116, 121-126 perceives a slight variation in the light refracted off object 144. Optical recorders 111-116 in first recorder array 110 record views of object 144, as do optical recorders 121-126 in second recorder array 120. Variations of the views of object 144 from each optical recorder 111-116 in first recorder array 110 correlate with variations in perception of object 144 by receptors in one human eye. Variations of the views of object 144 from each optical recorder 121-126 in second recorder array 120 correlate with variations in perception of object 144 by receptors of a second human eye.

As a scene is recorded, each optical recorder 111-116, 121-126 records, either directly or remotely, serial images 211-216, 221-226 on recording medium 170. Optical recorder 111, for example, may produce images 2111 through 2115 on recording medium 170, while optical recorder 121 simultaneously produces images 2211 through 2225 on either another or the same recording medium 170.

After a scene is recorded, serial images 211-216, 221-226 from all recording media 170 are organized and saved on a final storage medium 510. The quantity of individual images recorded during an event will vary depending upon the recording rate and the length of time during which recording occurs. However, the quantity of images in each series 211-216, 221-226 should be nearly the same for the same event.

In an illustrative sequence, individual images 2111-2268 from recorded series of images 211-216, 221-226 are selected and organized so that the earliest recorded image 2111 from first optical recorder 111 in first recorder array 110 is placed first in the sequence, followed by the recorded image 2212 of first optical recorder 121 in second recorder array 120, third recorded image 2123 of second optical recorder 112 in first recorder array 110, fourth recorded image 2224 from second optical recorder 122 of second recorder array 120, etc. In the preferred embodiment, each subsequent selected image is later in time than the immediately preceding image with the timing a predetermined amount (such as, for example 36 images per second).

In order to accomplish such sequencing, that optical recorders 111-116, 121-126 may be synchronized so that each optical recorder 111-116, 121-126 records each image 2111-2268 simultaneously and a limited number of the images acquired are actually used. Alternatively, recording by optical recorders 111-116, 121-126 may be synchronized to obtain serial images in succession corresponding to a determined rate.

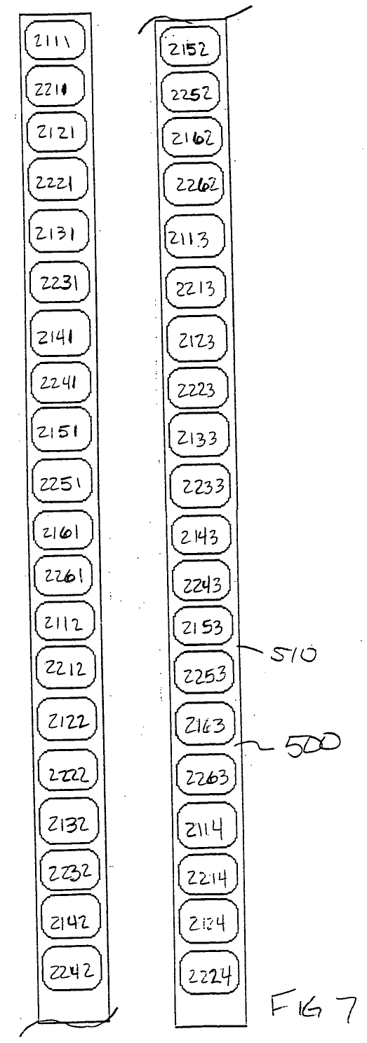

The predetermined order of images preferably alternates between an image 2111 from an optical recorder 111 in first recorder array 110 and an image 2211 from an optical recorder 121 in second recorder array 120. An example of such an image order, as shown in FIG. 7, may be:

| | Optical |
|---|---|
| Image | Recorder |
| 2111 | 111 |
| 2211 | 121 |
| 2121 | 112 |
| 2221 | 122 |
| 2131 | 113 |
| 2231 | 123 |
| 2141 | 114 |
| 2241 | 124 |
| 2151 | 115 |
| 2251 | 125 |
| 2161 | 116 |
| 2261 | 126 |
| 2112 | 111 |
| 2212 | 121 |
| 2122 | 112 |
| 2222 | 122 |
| 2132 | 113 |
| 2232 | 123 |
| 2142 | 114 |
| 2242 | 124 |
| 2152 | 115 |
| 2252 | 125 |
| 2162 | 116 |
| 2262 | 126 |

This order is maintained throughout the sequencing of all recorded images 2111 et al.

Although it is conceivable that each image 2111 et al. from each of serial images 211-216, 221-226 could be separated and spliced together in a manual operation, it is preferred that the recorded serial images 211-216, 221-226 be loaded onto a digital recording medium such as a compact disk or other storage device. Computer software may then be used to extract individual images 2111 et al. from serial images 211-216, 221-226 recorded by each optical recorder 111-116, 121-126 and organized in the manner described.

The sequenced serial images 500 are transmitted to a viewing device (not shown), such as a movie projector, video player, television, or computer.

In the preferred embodiment, images are displayed at a rate in excess of a traditional video transmission rate of twenty-four (24) images per second.

To provide optimal depiction of all images recorded with a determined number of optical recorders 130, the display speed (images per second) is multiplied by the number of optical recorders 130 used to record a scene. For example, if each optical recorder 130 records 24 images per second, as is typical for motion picture cameras, and twelve optical recorders 130 are used to record the scene, there will be a total of 288 images recorded during each second. All of the recorded images are sequenced as previously described. Therefore, to view all recorded images 500 in real time, 288 images per second (that is, 24 images per second per optical recorder times 12 optical recorders) must be viewed.

A preferred rate of displaying sequenced serial images 500 is, at minimum, 288 images per second. A lesser display rate may be used with decreasing effectiveness. Image generation may be with a single display device or multiple display devices each transmitting predetermined images of sequenced serial images 500.

Sequenced image series 500, which includes all of the nuances of perception from the plurality of optical recorders 130 in first and second recorder arrays 110, 120, depicted at such a high speed provides the nuances of reflected light perceived by human vision and accordingly provides three-dimensional perception of the scene viewed. The multiple locations simulate multiple reception points of rods and cones in a human eye processing pluralities of input in the visual spectrum at various locations of the retina. The space human eyes provide a triangulation effect. The present invention provides a plurality of reception points, spaced collectors and a rapid sequence of images to provide an effect to simulate actual human vision of a scene.

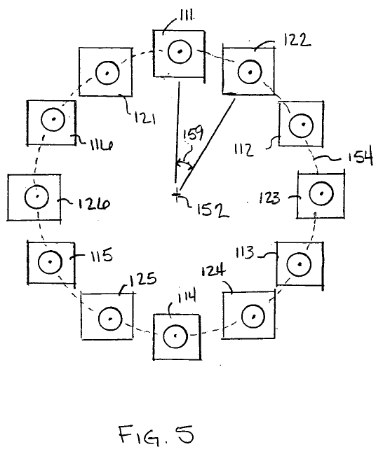

Referring to FIG. 5, in a second embodiment, a matrix arrangement 200 is depicted. Matrix arrangement 200 comprises a plurality of co-planar optical recorders 130 in a single recorder array 210. In the single recorder array 210, optical recorders 130 are placed at recorder locations 221-226, 231-236 equidistantly located around an array center point 252. Each recorder locations 221-226, 231-236 is separated by a distance 258 from adjacent recorder locations 221-226, 231-236. The distance from center point 252 to recorder locations 221-226, 231-236 need not equal the distance 258 between recorder locations 221-226, 231-236. Single recorder array 210 provides the advantage of the preferred embodiment in that the spaced optical recorders 130 capture variations in perspective and light and the nuances of reflected light perceived by human vision, but does not provide two spaced arrays. Images obtained by the single recorder array 210 are sequenced for subsequent display. The optical recorders 130 preferably include auto-focus, rotation and tracking capabilities as in the preferred embodiment previously described.

The foregoing description of the invention illustrates a preferred embodiment thereof. Various changes may be made in the details of the illustrated construction within the scope of the appended claims without departing from the true spirit of the invention. The present invention should only be limited by the claims and their equivalents.

1. A method for producing two-dimensional images of a scene on a substantially flat viewing surface to enable perception of three dimensions, comprising:
arranging a first plurality of optical recorders into a first recorder array;
arranging a second plurality of optical recorders into a second recorder array;
said first recorder array spaced from said second recorder array;
each of said first plurality of optical recorders recording a plurality of images of a scene onto at least one recording medium;
each of said second plurality of optical recorders recording a plurality of images of a scene onto at least one recording medium;
sequencing said plurality of images;
saving said sequenced images onto a final storage medium; and
displaying said sequenced images on a two-dimensional viewing medium.

2. The method of claim 1, further comprising:
said first plurality of optical recorders located within a first plane and spaced from each other;
said second plurality of optical recorders located within a second plane and spaced from each other.

3. The method of claim 2, further comprising:
positioning said first recorder array near said second recorder array such that said first recorder array and said second recorder array are co-planar.

4. The method of claim 2, wherein said arranging step further comprising:
placing each of said first plurality of optical recorders around a periphery of said first recorder array defining a first array midpoint; and
placing each of said second plurality of optical recorders around a periphery of said second recorder array defining second array midpoint.

5. The method of claim 4, said placing step further comprising:
each of said first plurality of optical recorders a first radius distance from said first array midpoint;
each of said second plurality of optical recorders a second radius distance from said second array midpoint;
each of said first plurality of optical recorders spaced from each other a first recorder separation distance;
each of said second plurality of optical recorders spaced form each other a second recorder separation distance;
said first radius distance equivalent to said second radius distance; and
said first recorder separation distance equivalent to said second recorder separation distance.

6. The method of claim 5, said placing step further comprising:
a first recorder offset angle defined by a radial line from said first array midpoint to one said first plurality of optical recorders and a midpoint line from said first array midpoint to said second array midpoint;
a second recorder offset angle defined by a radial line from said second array midpoint to one said second plurality of optical recorders and a line from said first array midpoint to said second array midpoint; and
said first recorder offset angle differing from said second recorder offset angle for all said first offset angles and all said second offset angles.

7. The method of claim 2, said sequencing step further comprising:
extracting a plurality of first array images from said first plurality of optical recorders;
placing said plurality of first array images onto a final storage record;
extracting a plurality of second array images from said second plurality of optical recorders;
placing said plurality of second array images onto a final storage record; and
alternating first array images and second array images on said final storage record.

8. The method of claim 2, said sequencing step further comprising:
extracting a first image from a first optical recorder from said first array;
placing said first image onto a final storage record;
extracting a second image from a first optical recorder from said second array;
placing said second image onto a final storage record;
extracting a third image from a second optical recorder from said first array;
placing said third image onto a final storage record;
extracting a fourth image from a second optical recorder from said second array;
placing said fourth image onto a final storage record;
extracting a fifth image from a third optical recorder from said first array;
placing said fifth image onto a final storage record;
extracting a sixth image from a third optical recorder from said second array;
placing said sixth image onto a final storage record; and
repeating said extracting and placing steps until a first set of images is extracted from all said plurality of optical recorders.

9. The method of claim 8, said sequencing step further comprising:
repeating said extracting and placement steps continuously until a plurality of sets of images is extracted from all said plurality of optical recorders.

10. The method of claim 9, said sequencing step further comprising:
repeating said extracting and placement steps continuously during a determined time period.

11. An apparatus for gathering two-dimensional images of a scene for subsequent display on a substantially flat viewing surface to enable perception of three dimensions, comprising:
a first plurality of optical recorders in a first recorder array;
a second plurality of optical recorders in a second recorder array;
said first recorder array spaced from said second recorder array;
at least one recording medium;
each of said first plurality of optical recorders operable to record a plurality of images of a scene onto said at least one recording medium;
each of said second plurality of optical recorders recording a plurality of images of a scene onto said at least one recording medium;
said first plurality of optical recorders located within a first plane and spaced from each other; and
said second plurality of optical recorders located within a second plane and spaced from each other.

12. The apparatus of claim 11, further comprising:
said first recorder array positioned near said second recorder array such that said first recorder array and said second recorder array are co-planar.

13. The apparatus of claim 11, further comprising:
said first array having a first array midpoint;
said first plurality of optical recorders located around a periphery of said first recorder array spaced from said first array midpoint;
said second array having a second array midpoint;
said second plurality of optical recorders located around a periphery of said second recorder array spaced from said second array midpoint.

14. The apparatus of claim 13, wherein:
each of said first plurality of optical recorders a first radius distance from said first array midpoint;
each of said second plurality of optical recorders a second radius distance from said second array midpoint;
each of said first plurality of optical recorders spaced from each other a first recorder separation distance;
each of said second plurality of optical recorders spaced form each other a second recorder separation distance;
said first radius distance equivalent to said second radius distance; and
said first recorder separation distance equivalent to said second recorder separation distance.

15. The apparatus of claim 14, wherein:
a first recorder offset angle defined by a radial line from said first array midpoint to one said first plurality of optical recorders and a midpoint line from said first array midpoint to said second array midpoint;
a second recorder offset angle defined by a radial line from said second array midpoint to one said second plurality of optical recorders and a line from said first array midpoint to said second array midpoint; and
said first recorder offset angle differing from said second recorder offset angle for all said first offset angles and all said second offset angles.

16. The apparatus of claim 14, wherein:
each said plurality of optical recorders having an optical recorder housing; and
each optical recorder housing operable to track a moving object.

17. The apparatus of claim 14, wherein:
each said plurality of optical recorders having an optical recorder housing;
each said plurality of optical recorders having a viewing lens; and
each said viewing lens operable to track a moving object.

18. The apparatus of claim 14, wherein:
said first array and said second array supported on a common support fixture.

19. An apparatus for gathering two-dimensional images of a scene for subsequent display on a substantially flat viewing surface to enable perception of three dimensions, comprising:
a plurality of optical recorders in a single recorder array;
said plurality of optical recorders arranged in a plane;
said array having an array center point;
said plurality of optical recorders equidistantly located around said array center point;
each of said plurality of optical recorders equidistantly located from the next adjacent each of said plurality of optical recorders;
at least one recording medium;
each of said plurality of optical recorders operable to record a plurality of images of a scene onto said at least one recording medium;
said array having an array midpoint; and
said plurality of optical recorders located around a periphery of said recorder array spaced from said array midpoint.

20. The apparatus of claim 19, wherein:
each said plurality of optical recorders having an optical recorder housing; and
each optical recorder housing operable to track a moving object.

21. The apparatus of claim 19, wherein:
each said plurality of optical recorders having an optical recorder housing;
each said plurality of optical recorders having a viewing lens; and
each said viewing lens operable to track a moving object.
